(19) United States
(12) Patent Application Publication
(10) Pub. No.: US 2004/0030896 A1
(43) Pub. Date: Feb. 12, 2004

(54) IC card and cryptographic communication method between IC cards

(75) Inventors: Ken Sakamura, Tokyo (JP); Noboru Koshizuka, Musashino-shi (JP); Hiroshi Aono, Tokyo (JP); Kazuhiko Ishii, Tokyo (JP); Kensaku Mori, Tokyo (JP); Sadayuki Hongo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Ken SAKAMURA, Tokyo (JP); Noboru KOSHIZUKA, Musashino-shi (JP); NTT DoComo, Inc., Tokyo (JP)

(21) Appl. No.: 10/457,523

(22) Filed: Jun. 10, 2003

(30) Foreign Application Priority Data
Jun. 10, 2002 (JP) P2002-169193

(51) Int. Cl. H04L 9/00

(52) U.S. Cl. 713/169; 713/194

(57) ABSTRACT

A cryptographic communication method between IC cards in an electronic ticket distribution system is provided, wherein when a server and a user terminal, to each of which an IC card is connected, begin mutual data-communication or when an IC card and, a ticket collecting machine begin mutual data-communication, they both dynamically change encryption algorithms for mutual authentication and for concealment of contents to be transmitted in accordance with information about commonly usable encryption algorithms exchanged at the beginning of a mutual authentication between them, and this procedure at the beginning of the mutual authentication can result in a speedy and secured cryptographic communication between them.

### CROSS-REFERENCE TO RELATED APPLICATION

This application is based upon and claims the benefit of priority from the prior Japanese Patent Application No. 2002-169193, filed on Jun. 10, 2002. The entire contents of which are incorporated herein by reference.

### BACKGROUND OF THE INVENTION

1. Field of the Invention

The present invention relates to an IC card, and a cryptographic communication method between IC cards. More particularly, the present invention relates to an IC card to be used in a communication terminal, and a cryptographic communication method between IC cards or between an IC card and a tamper-resistant apparatus having an equivalent function to an IC card. The present invention further relates to a cryptographic communication method used in an electronic ticket distribution system.

2. Description of the Related Art

Cryptographic communication technologies, such as “Internet Draft The SSL Protocol Version 3.0” and “RFC2246 The TLS Protocol Version 1.0” are well known nowadays. Since these technologies do not largely change the schemes of the present network techniques and network protocols, they are very effective for transmitting critical information such as personal information and credit card numbers secretly on an open network such as the Internet. Software-based installation and hardware-based installation such as a PCI-type cryptographic key have been developed, and various products are commercially available nowadays.

However, a cryptographic communication technology for application to IC cards remains still unknown. Furthermore, there are no common interfaces used for cryptographic algorithms in IC cards. Hence, it is always necessary to rearrange a calling port of cryptographic algorithm when the cryptographic algorithm in use is changed.

### SUMMARY OF THE INVENTION

It is an object of the present invention to provide a cryptographic communication technology between IC cards capable of changing a cryptographic algorithm in use without changing a predetermined communication protocol.

The object described above is achieved by a cryptographic communication method between a first IC card and a second IC card, comprising the steps of: (1) a mutual authentication at the beginning of data communication between the first IC card and the second IC card, comprising exchanging information about a usable encryption algorithm between the first IC card and the second IC card in order to select a commonly usable encryption algorithm between the first IC card and the second IC card; (2) in the first IC card, encrypting a plain text data to be sent into an encrypted data by using the selected commonly usable encryption algorithm; converting the encrypted data into a transmission data with a format required by a predetermined protocol; and transmitting the transmission data to a communication media; and (3) in the second IC card, receiving the transmission data from the communication media; reversely converting the received transmission data into an encrypted data the same as the original encrypted data sent by the first IC card; and decrypting the encrypted data to a plain text data to be sent the same as the original plain text data sent by the first IC card by using the selected commonly usable encryption algorithm.

In the cryptographic communication method between the first IC card and the second IC card mentioned above, the first and the second IC cards can include a device having an equivalent function to an IC card.

In the cryptographic communication method between the first IC card and the second IC card mentioned above, It is possible to enable both the first and the second IC cards to have information in order of priority of usage among a plurality of encryption algorithms; and in the mutual authentication at the beginning of data communication between the first and the second IC cards, to exchange information of usable encryption algorithms between the first and the second IC cards in order to select an encryption algorithm that is given a highest order of priority of usage among the commonly usable encryption algorithms between the first and the second IC cards.

The object described above is also achieved by a cryptographic communication method between a first IC card and a second IC card, wherein both the first IC card and the second IC card having a switching means of encryption algorithms and a protocol processing means, comprising the steps of: (1) a mutual authentication at the beginning of data communication between the first IC card and the second IC card, comprising exchanging information about a usable encryption algorithm between the first IC card and the second IC card to select a commonly usable encryption algorithm between the first IC card and the second IC card by their switching means of encryption algorithms; (2) in the first IC card, passing a plain text data to be sent to the switching means of encryption algorithms thereof; (3) in the switching means of encryption algorithms of the first IC card, encrypting the plain text data to be sent into an encrypted data by using the commonly usable encryption algorithm, converting the encrypted data into a transmission data with a format required by a predetermined protocol, and passing the transmission data to the protocol processing means of the first IC card: (4) in the protocol processing means of the first IC card, converting the transmission data into a transmission data signal in compliance with a predetermined protocol and transmitting it to a communication media; (5) in the protocol processing means of the second IC card, receiving the transmission data signal from the communication media and reversely converting the transmission data signal into a transmission data the same as the original transmission data in the first IC card and passing to the switching means of encryption algorithms of the second IC card; and (6) in the switching means of encryption algorithms of the second IC card, reversely converting the transmission data into an encrypted data the same as the original encrypted data sent by the first IC card, and decrypting the encrypted data into a plain text data to be sent the same as the original plain text data by using the commonly usable encryption algorithm.

In the cryptographic communication method between the first IC card and the second IC card mentioned above, the first and the second IC cards can include a device having an equivalent function to an IC card.

In the cryptographic communication method between the first IC card and the second IC card mentioned above, it is possible to enable both the first and the second IC cards to have information in order of priority of usage among a plurality of encryption algorithms; and in a mutual authentication at the beginning of data communication between the first and the second IC cards, to exchange information of usable encryption algorithms between the first and the second IC cards in order to select an encryption algorithm that is given a highest order of priority of usage among the commonly usable encryption algorithms between the first and the second IC cards.

The object described above is also achieved by a cryptographic communication method between IC cards in an electronic ticket distribution system, wherein the electronic ticket distribution system comprising: a server having a tamper resistant device, the device which issues and sells electronic tickets, and which has a first function means equivalent to an IC card; a user terminal having an electrical communication means and having an interface for signal exchange with an IC card, the IC card which is connected to the interface and executes the purchase and storage of an electric ticket; and a ticket collecting machine, which has a second function means equivalent to an IC card, for collecting electronic tickets upon their usage; the method comprising the steps of: exchanging information about a commonly usable encryption algorithm at the beginning of a mutual authentication between the IC card and the first or the second function means equivalent to an IC card; and selecting an encryption algorithm commonly usable between the IC card and the first or the second function means equivalent to an IC card as an encryption algorithm to be used for mutual authentication and for concealment of transmission data between the IC card and the first or the second function means equivalent to an IC card, according to the information exchanged at the beginning of the mutual authentication between the IC card and the first or the second function means equivalent to an IC card.

The object described above is also achieved by an IC card comprising: a selector of encryption algorithm for selecting a commonly usable encryption algorithm as an encryption algorithm for mutual communication with an opposite IC card, according to an exchange of information about a usable encryption algorithm between the opposite IC card at the beginning of mutual authentication with the opposite IC card; an encryption means for encrypting a plain text data to be sent into a first encrypted data by using the selected encryption algorithm; a decryption means for decrypting a second encrypted data received from a communication media by using the selected encryption algorithm; a converting means for converting the first encrypted data using the encryption means into a first transmission data, which is conformed to a predetermined protocol, and for transmitting the first transmission data to the communication media; and a reversely converting means for reversely converting a second transmission data received from the communication media into the second encrypted data, and for passing the second encrypted data to the decryption means.

In the IC card mentioned above, it is possible to enable the selector of encryption algorithm to store information in order of priority of usage among a plurality of encryption algorithms stored therein, and, at the beginning of the mutual authentication with the opposite IC card, to exchange information of encryption algorithms being commonly usable with the opposite IC card and select an encryption algorithm that is given a highest order of priority of usage among the commonly usable encryption algorithms between this IC card and the opposite IC card.

In the IC card mentioned above, this IC card and the opposite IC card can include a device having an equivalent function to an IC card.

By using the cryptographic communication method between the first IC card and the second IC card mentioned above, an encrypted data in the first IC card or the like (hereinafter referred to as the first IC card) is transmitted to the second IC card or the like (also referred to a second IC card) through the communication media, and in the second IC card, the encrypted data from the first IC card is decrypted to the original plain text data. And in the mutual authentication at the beginning of data communication between the first and the second IC cards, the switching means of encryption algorithms in the first and second IC cards exchange information about usable encryption algorithms and select a commonly usable encryption algorithm in their mutual communication. Then, the first IC card passes to the switching means of encryption algorithms a plain text data to be sent from a memory therein, and the switching means of encryption algorithms of the first IC card encrypts the plain text data into an encrypted data by using the selected commonly usable encryption algorithm, converts the encrypted data into a transmission data with a format required by the predetermined protocol, and passes the transmission data to the protocol processing means of the first IC card, The protocol processing means of the first IC card converts the transmission data into a transmission data signal that complies with the predetermined protocol and transmits to the second IC card via the communication media.

When the second IC card receives the transmission data from the first IC card, the protocol processing means of the second IC card reversely converts the transmission data signal into the original transmission data of the first IC card and passes it to the switching means of encryption algorithms of the second IC card, The switching means of encryption algorithms of the second IC card reversely converts the transmission data into the original encrypted data, and decrypts the encrypted data into the original plain text data the same as the original plain text data of the first IC card by using the selected commonly usable encryption algorithm.

According to this cryptographic communication technology of the present invention, by merely installing into each IC card the switching means of encryption algorithms that has respective conversion rules between plural encryption algorithms and a predetermined single common communication protocol, the IC cards enable cryptographic communication to occur between user terminals, to which the IC cards are connected, on a basis of the predetermined common communication protocol without any changes in communication function provided therein.

Further, according to the cryptographic communication technology of the present invention, by setting an order of priority among plural encryption algorithms stored in each IC card, and selecting the encryption algorithm of the highest order of priority among the plural encryption algorithms commonly usable between both IC cards in accordance with communication speed available in the communication media or in accordance with contents to be transmitted between the IC cards, very effective and speedy communication between the IC cards is possible.

By using the cryptographic communication method between IC cards in an electronic ticket distribution system, where a server and a user terminal, to which IC cards are connected, begin mutual data communication or when an IC card and a ticket collecting machine begin mutual data communication, they can both dynamically change encryption algorithms used for mutual authentication and for concealment of contents to be transmitted in accordance with information about commonly usable encryption algorithms exchanged at the beginning of the mutual authentication between them. This procedure at the beginning of the mutual authentication can result in a speedy and secured cryptographic communication between them.

According to the IC card mentioned above of the present invention, by connecting a plurality of these IC cards to a first and second user terminals, respectively, selectors of encryption algorithm of both IC cards connected to respective user terminals exchange information of usable encryption algorithms at the beginning of mutual authentication, and select a commonly usable encryption algorithm as an encryption algorithm for the mutual communication. Next, in the first IC card connected to the first user terminal, the encryption means encrypts a plain text data to be sent into an encrypted data by using the selected encryption algorithm and the converting means converts the encrypted data into a transmission data, which conforms to a predetermined protocol employed in the first user terminal. The first user terminal transmits the transmission data from the first IC card to the communication media.

The second user terminal, to which the second IC card is connected, receives the transmitted transmission data from the communication media and passes the transmission data to the reversely converting means of the second IC card. The reversely converting means reversely converts the transmission data into the original encrypted data and passes it to the decryption means in the second IC card. The decryption means decrypts the original encrypted data into the original plain text data the same as that of the first IC card by using the selected encryption algorithm.

According to this cryptographic communication procedure realized by the IC cards, by merely installing into each IC card the switching means of encryption algorithms that has respective conversion rules between plural encryption algorithms and a predetermined common communication protocol, the IC cards enable cryptographic communication between user terminals, to which the IC cards are connected, on a basis of the predetermined common communication protocol without any changes to the communication function provided therein.

### BRIEF DESCRIPTION OF THE DRAWINGS

FIG. 1 is a block diagram showing a cryptographic communication system between IC cards of one embodiment of the present invention.

FIG. 2 is a block diagram showing a communication procedure carried out by IC cards in the embodiment mentioned above.

FIG. 3 is a block diagram showing a functional structure of an IC card used in the embodiment mentioned above.

FIG. 4 is a schematic diagram showing an inner configuration of an IC chip included in an IC card, which is used in the cryptographic communication system of the embodiment.

FIG. 5 is a schematic diagram showing an electronic ticket distribution system.

FIG. 6 is a sequential flowchart showing a cryptographic communication method between IC cards of the embodiment.

FIG. 7 is a flowchart showing a converting procedure and a reversely converting procedure of encrypted data according to the cryptographic communication method of the embodiment.

FIG. 8 is a list of encryption algorithms usable in the IC card in the cryptographic communication method of the embodiment.

FIG. 9 is a list of encryption algorithms and parameters usable in the cryptographic communication method of the embodiment.

### DETAILED DESCRIPTION OF THE PREFERRED EMBODIMENTS

Embodiments of the present invention will be explained in detail with reference to the accompanied drawings.

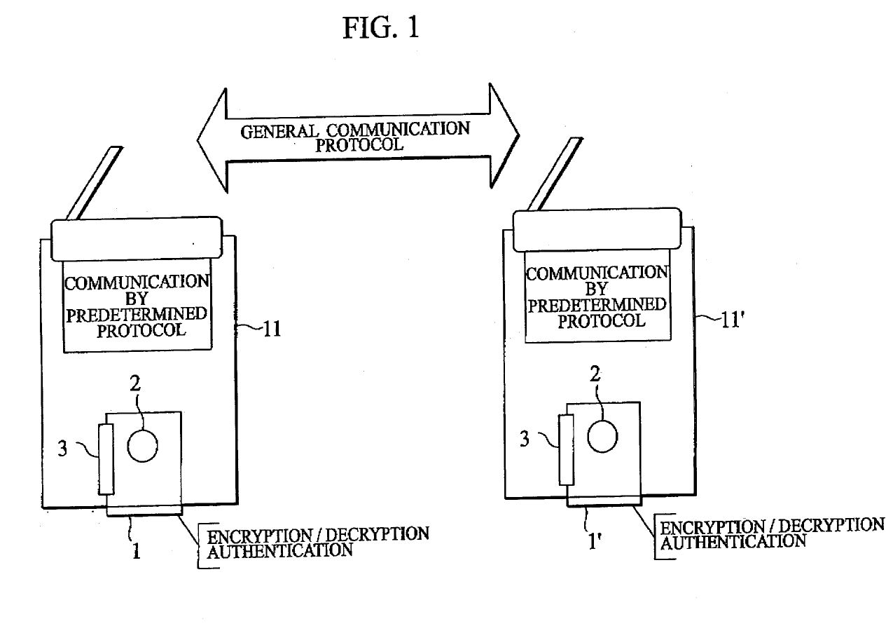

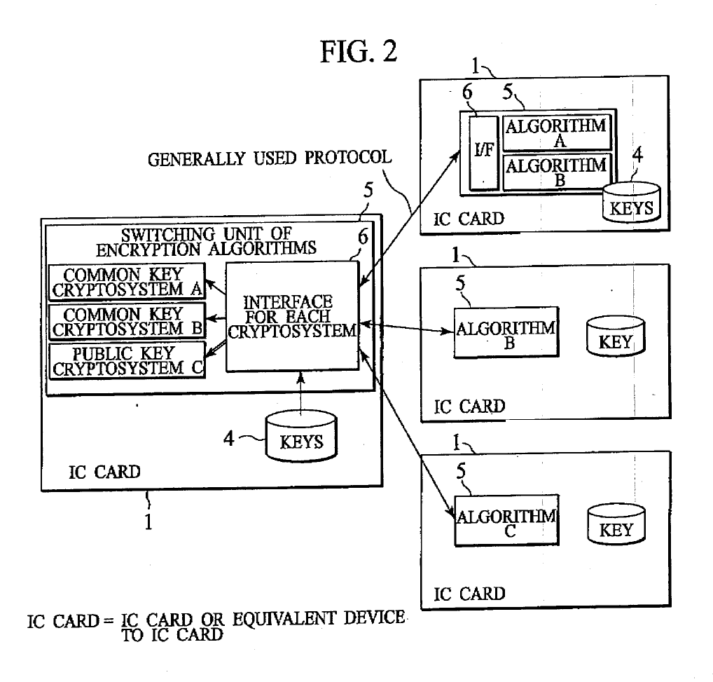

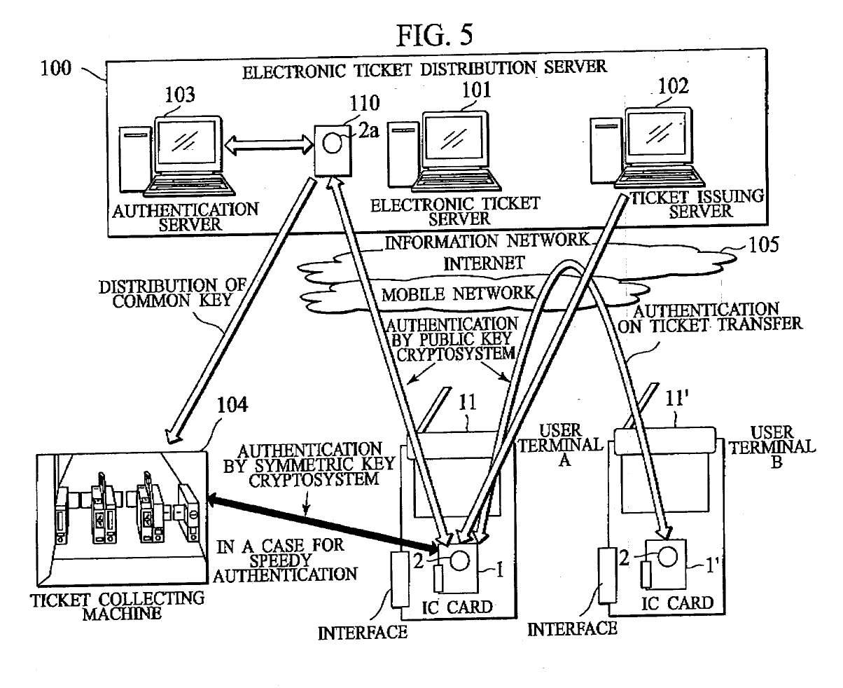

A cryptographic communication system between IC cards of one embodiment of the present invention is shown in FIGS. 1-3. The cryptographic communication system between IC cards is usable for cryptographic authentication and cryptographic data transmission in an electronic ticket distribution system as shown in FIG. 5, wherein the electronic ticket distribution system comprises an electronic ticket server 101, a ticket issuing server 102, an authentication server 103, one or plural user terminals 11 and 11′, and a ticket collecting machine 104. These components are able to connect to an information network 105 for mutual communications. The information network 105 includes the Internet, a mobile network and other wired or wireless networks.

In the electronic ticket distribution system as shown in FIG. 5, the electronic ticket server 101 has a tamper resistant device 110, which has an equivalent function to an IC card and sells electronic tickets. The ticket issuing server 102 issues electronic tickets to appointed customers in response to requests from the electronic ticket server 101. The authentication server 103 authenticates a public key and an electronic signature. Hereinafter, a group of these servers 101, 102 and 103 is called an electronic ticket distributing server 100 for simplicity of explanation.

Each of the user terminals 11 and 11′ has an electrical communication device and an interface such as a connecting port and an IC card slot for signal exchange with an IC card 1 or 1′ connected thereto. Each of the user terminals 11 and 11′ can carry out a procedure of purchasing and storing electric tickets in cooperation with the IC card 1 or 1′, where these IC cards are connected to each of the user terminals. The ticket collecting machine 104 has an equivalent function to an IC card and collects electronic tickets from IC cards by cryptographic communication with the IC cards when the electronic tickets are used.

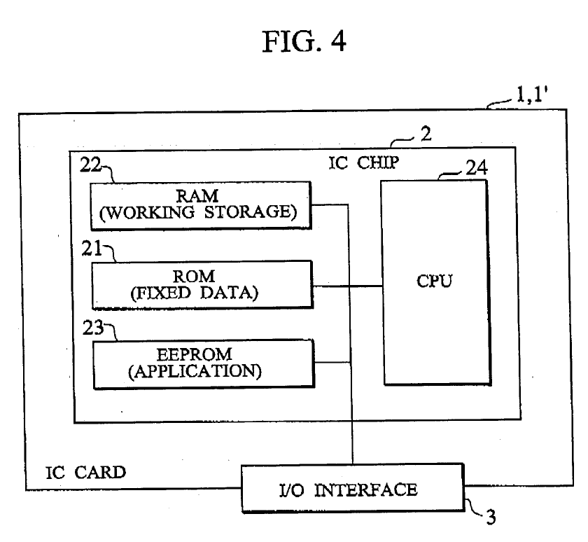

Referring to FIGS. 1-3, an IC chip 2 is incorporated in each of the IC cards 1 and IC card 1′. A contact-type or noncontact-type interface 3 is provided to each of the IC cards 1 and 1′. As shown precisely in FIG. 4, the IC chip 2 includes a ROM 21 for storing an OS program and other fixed programs and fixed data, a RAM 22 as working storage, an EEPROM 23 for storing an application program, and a CPU 24 for processing operations.

When a user wants to purchase an electronic ticket, first, the user should insert the IC card 1 to the card slot of the user terminal 11 to connect the interface 3 with a corresponding interface provided in the user terminal 11 for mutual communication between them. Next, the user should connect the user terminal to the information network 105 to access to the electronic ticket distributing server 100, and take necessary procedures for purchase from the user terminal 11. By this operation from the user terminal 11, a purchased electronic ticket is transmitted from the electronic ticket distributing server 100 into the RAM in the IC chip 2 of the IC card 1 and stored therein. Together with the data of the electronic ticket, data of a common key or secret information is transmitted. This common key or the secret information is also stored in the RAM. The common key or secret information is provided for mutual authentication between the IC card 1 and the ticket collecting machine 104 based on a symmetric key cryptosystem.

Contents of information for cryptographic key data 4 stored in the IC card 1 are (1) information of a private key of a user and of a public key of the electronic ticket distributing server 100, necessary for mutual authentication on a public key cryptosystem, and (2-1) information of a private key of the user and a public key of the ticket collecting machine, in a case where a public key cryptosystem is used in communication between the IC card 1 and the ticket collecting machine 104, or (2-2) information of a common key or shared secret necessary for producing a secret key, in a case where a symmetric key cryptosystem is used in communication between the IC card 1 and the ticket collecting machine 104.

A switching unit of encryption algorithms 5 built in the IC chip 2 as an application software includes one or plural encryption algorithms A, B and C, and an interface for each cryptosystem 6. This interface for each cryptosystem 6 has a processing function of converting encrypted data, which is encrypted in the IC chip by one of the encryption algorithms stored therein, into data of a predetermined communication protocol, and of reversely converting a received data of the predetermined communication protocol into an original encrypted data, which is fitted to one of the encryption algorithms stored in the IC chip 2. This function of the interface 6 will be explained in detail later.

It should be noted that each encryption algorithm that is used between the IC card 1 and the electronic ticket distributing server 100 upon purchasing an electronic ticket by the IC card 1, the encryption algorithm that is used between the IC card 1 and an other IC card 1′ via user terminals 11 and 11′ in communicating with each other in order to transfer an electronic ticket, and the encryption algorithm that is used between the IC card 1 and the ticket collecting machine 104 in verifying the electronic ticket may differ from each other according to the types of server 100, types of IC cards 1 and 1′, and types of ticket collecting machine 104.

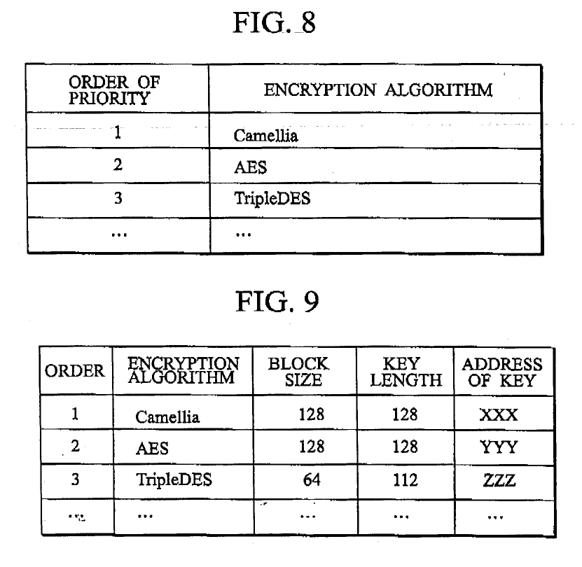

For instance, possible encryption algorithms are such as “Camellia” and “AES” for the symmetric key cryptosystem and “Triple DES” for the public key cryptosystem and others, as is shown in FIG. 8. It is preferable to give an order of priority among the encryption algorithms for mutual communication according to types of IC cards and types of ticket collecting machines. The order of priority is determined according to whether speed or security should be prioritized, and also by taking into account machinery performance. At the beginning of mutual authentication between IC cards or between an IC card and a tamper resistant device having an equivalent function to an IC card, information about types of encryption algorithms stored therein and the order of priority among the encryption algorithms is exchanged as shown in FIG. 8. An encryption algorithm of the highest priority among mutually usable encryption algorithms is selected for their mutual authentication and communication. The list data as shown in FIG, 8 is stored in the ROM or the EEPROM of the IC chip 2 in an IC card.

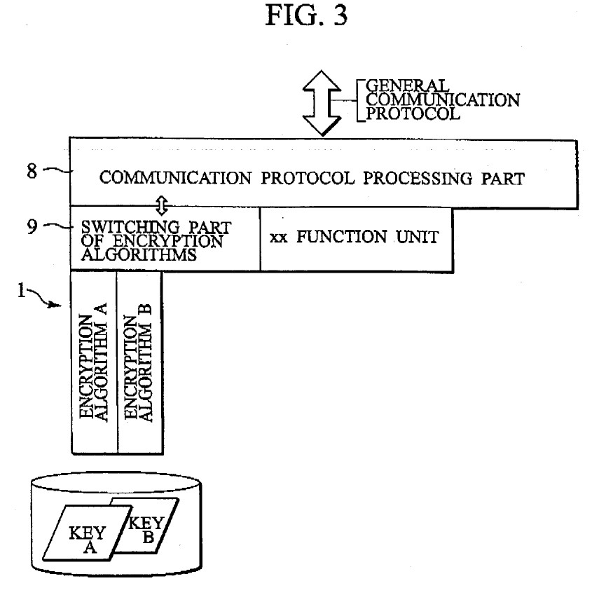

Referring to FIG. 3, in the switching unit of encryption algorithms 5 of the IC card 1, an interface between a communication protocol processing part 8 and a switching part of encryption algorithms 9 are included as a common interface, and four parameters of a cryptographic type, encrypted-data/plain-data, cryptographic key and encryption/decryption are employed therein. The switching part of encryption algorithms 9 converts data so as to comply with a parameter for an encryption algorithm, the parameter that is selected based on a parameter conversion table as shown in FIG. 9, and passes the parameter to a designated encryption algorithm.

Hereinafter, a cryptographic communication method executed by the cryptographic communication system between IC cards of this embodiment will be explained. Referring to FIG. 3, the IC card 1 holds encryption keys A and B. These encryption keys A and B are for respective encryption algorithms A and B to encrypt and decrypt by using these keys. The switching part of encryption algorithms 9 converts data of a predetermined protocol that is received by the communication protocol processing part 8, to an encrypted data. This encrypted data can be decrypted by the IC card 1 via the encryption algorithm A or B. The switching part of encryption algorithms 9 also converts encrypted data encrypted by one of the encrypted algorithms A and B held in the IC card 1 into transmission data, which complies with the predetermined communication protocol, and passes it to the communication protocol processing part 8. In a case where wireless communication with a user terminal 11 is executed via a noncontact type interface, the communication protocol processing part 8 transmits and receives wireless signals that comply with a predetermined wireless communication protocol. In a case where wired communication with the user terminal 11 is executed via a contact type interface, the communication protocol processing part 8 transmits and receives communication signals that comply with a predetermined wired communication protocol.

Hereinafter, a cryptographic communication procedure carried out by a switching unit of encryption algorithms 5 will be explained. As is shown in FIG. 1, assume that the user terminal 11, to which the IC card 1 is connected, communicates with opposite user terminal 11′, to which the IC card 1′ is connected, in order to transfer an electronic ticket by wireless.

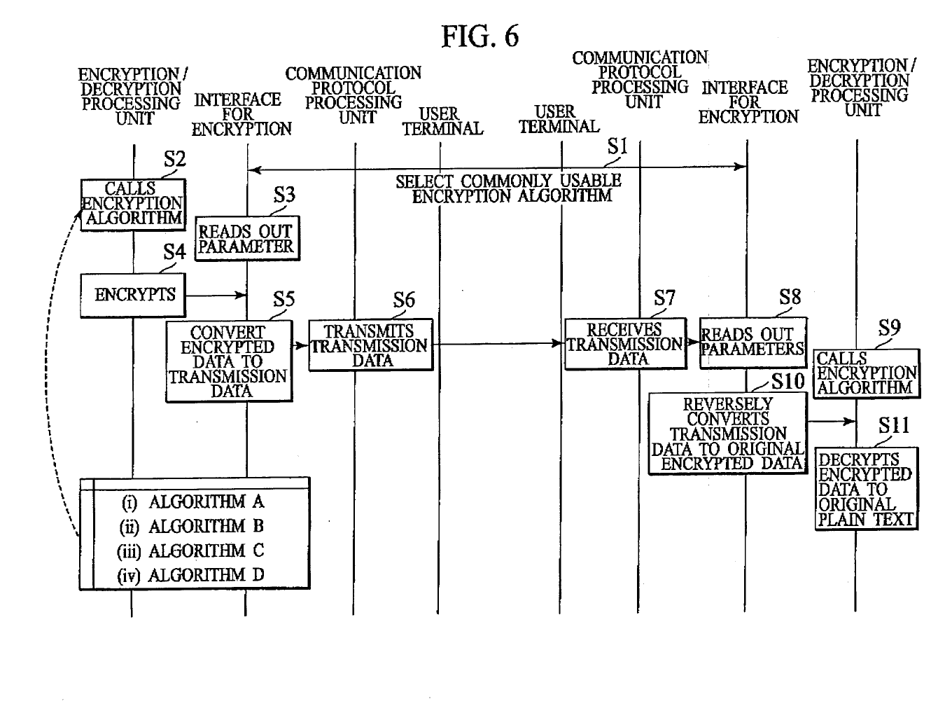

In step S1 of the flowchart shown in FIG. 6, the IC cards 1 and 1′ exchange information about commonly usable encryption algorithms at the beginning of the mutual communication in order to select an encryption algorithm to be used in mutual authentication and an encryption algorithm to be used for concealment of transmission data between them. The encryption algorithm(s) is determined by referring to the list of usable encryption algorithms and the order of priority as shown in FIG. 8. Here, suppose that the Triple DES algorithm is selected for both mutual authentication and concealment of the transmission data.

In steps S2 through S5, when the IC card 1 has determined the encryption algorithm to be used, the interface for each cryptosystem 6 in the switching unit of encryption algorithms 5 reads out parameters for data conversion between the selected encryption algorithm and the predetermined communication protocol, and converts the encrypted data using the parameters.

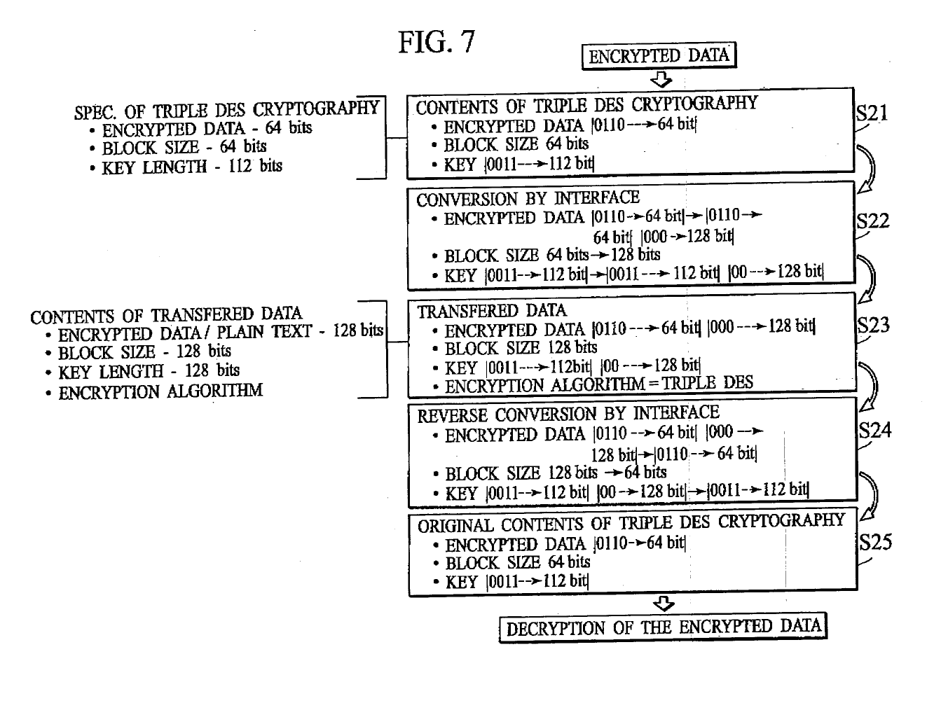

In a case where the selected encryption algorithm is the Triple DES, at step S21 of the flowchart in FIG. 7, the parameters are determined as 64 bits of block size, 128 bits of key length and ZZZ of key address as shown on the table in FIG. 9. In addition, a block length of transfer packet is determined as 128 bits.

In step S22 of the flowchart in FIG. 7, the interface for each cryptosystem 6 processes to fill zeros into 65th bit through 128th bit of encrypted data of 65 bits per unit in order to produce data of 128 bits per unit, wherein the data length of 128 bits is the block length of the packet to be transferred on the communication media. For the information of cryptographic key or the secret information to be sent to an opposite IC card, the interface for each cryptosystem 6 also processes to fill zeros into 113th bit through 128th bit of the encrypted data of 112 bits per unit in order to produce data of 128 bits per unit. The interface for each cryptosystem 6 passed these data of 128 bits per unit to the communication protocol processing part 8. The interface for each cryptosystem 6 attaches information of encryption algorithm used for conversion to the converted data.

Receiving the converted data from the switching part of encryption algorithms 9, the communication protocol processing part 8 passes the data to the user terminal 11. The user terminal 11 converts the data into transmission data signals and transmits to the opposite user terminal 11′ (step S6 of the flowchart in FIG. 6 and step S23 of the flowchart in FIG. 7).

In step S7 of the flowchart in FIG. 6, the transmission data signals are received by the opposite user terminal 11′, and the signals are passed to the communication protocol processing part 8. The communication protocol processing part 8 reversely converts the received data signals into original data of the predetermined communication protocol and passes it to the switching part of encryption algorithms 9.

In the opposite IC card 1′, its switching part of encryption algorithms 9 reads out parameters of the encryption algorithm in the same method as set forth in step S4, and reversely converts the received packet data of 128 bits per unit into the original encrypted data (steps S8 and S9 of the flowchart in FIG. 6, and steps S24 and S25 of the flowchart in FIG. 7). Further, in the opposite IC card 1′, the selected encryption algorithm decrypts the original encrypted data into the original plain text data, which originated in the IC card 1 (steps S10 and S11 of the flowchart in FIG. 6).

The same methods of encryption processes, the data conversion conforming to the predetermined communication protocol, the data transmission/reception on the predetermined communication protocol, the reverse conversion of the received data into the original encrypted data and the decryption of the encrypted data into the original plain text can be equally adopted by the opposite IC card 1 when it transmits encrypted data to the IC card 1.

According to this cryptographic communication technology of the present invention, by merely installing into each IC card a switching means of encryption algorithms that has respective conversion rules between plural encryption algorithms and a predetermined single common communication protocol, the IC card can enable cryptographic communication between user terminals, to which the IC cards are connected, on the basis of a predetermined single common communication protocol without any changes in communication function provided therein.

Further, according to the cryptographic communication method between IC cards in an electronic ticket distribution system, when a server and a user terminal, to each of which an IC card is connected, begin mutual data communication or when an IC card and a ticket collecting machine begin mutual data communication, they both can dynamically change encryption algorithms used for mutual authentication and for concealment of contents to be transmitted in accordance with information of commonly usable encryption algorithms selected at the beginning of the mutual authentication between them, and this procedure at the beginning of the mutual authentication can result in a speedy and secured cryptographic communication between them.

Furthermore, according to the IC card of the present invention mentioned above, by merely installing a switching means of encryption algorithms into each IC card, the means having respective conversion rules between plural encryption algorithms and a predetermined single common communication protocol, the IC card enables cryptographic communication to occur between user terminals, to each of which the IC card is connected, on the basis of the predetermined single common communication protocol without any changes in communication function provided therebetween.

What is claimed is:

1. A cryptographic communication method between a first IC card and a second IC card, comprising the steps of:
in a mutual authentication at the beginning of data communication between the first IC card and the second IC card,
exchanging information about a usable encryption algorithm between the first IC card and the second IC card in order to select a commonly usable encryption algorithm between the first IC card and the second IC card;
in the first IC card,
encrypting a plain text data to be sent into an encrypted data by using the selected commonly usable encryption algorithm;
converting the encrypted data into a transmission data with a format required by a predetermined protocol; and
transmitting the transmission data to a communication media; and
in the second IC card,
receiving the transmission data from the communication media;
reversely converting the received transmission data into an encrypted data the same as the original encrypted data sent by the first IC card; and
decrypting the encrypted data into a plain text data the same as the original plain text data sent by the first IC card by using the selected commonly usable encryption algorithm.

2. A cryptographic communication method between IC cards in an electronic ticket distribution system,
wherein the electronic ticket distribution system comprising:
a server having a tamper resistant device, the device which issues and sells electronic tickets, and which has a first function means equivalent to an IC card;
a user terminal having an electrical communication means and having an interface for signal exchange with an IC card, the IC card being connected to the interface and executes purchase and storage of an electric ticket; and
a ticket collecting machine, which has a second function means equivalent to an IC card, for collecting electronic tickets upon their usage;
the method comprising the steps of:
exchanging information about a commonly usable encryption algorithm at the beginning of a mutual authentication between the IC card and the first or the second function means equivalent to an IC card; and
selecting an encryption algorithm commonly usable between the IC card and the first or the second function means equivalent to an IC card as an encryption algorithm to be used for mutual authentication and for concealment of communication data between the IC card and the first or the second function means equivalent to an IC card, according to the information exchanged at the beginning of the mutual authentication between the IC card and the first or the second function means equivalent to an IC card.

3. An IC card comprising:
a selector of encryption algorithm for selecting a commonly usable encryption algorithm as an encryption algorithm for mutual communication with an opposite IC card, according to an exchange of information about a usable encryption algorithm between the opposite IC card at the beginning of a mutual authentication with the opposite IC card;
an encryption means for encrypting a plain text data to be sent into a first encrypted data by using the selected encryption algorithm;
a decryption means for decrypting a second encrypted data received from a communication media by using the selected encryption algorithm;
a converting means for converting the first encrypted data by the encryption means into a first transmission data, in accordance with a predetermined protocol, and for transmitting the first transmission data to the communication media; and
a reversely converting means for reversely converting a second transmission data received from the communication media into the second encrypted data, and for passing the second encrypted data to be sent to the decryption means.
